(19) United States
(12) Patent Application Publication
(10) Pub. No.: US 2014/0131092 A1
(43) Pub. Date: May 15, 2014

(54) CABLE MANAGEMENT APPARATUS

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: MING-YU LIU, Shenzhen (CN); AN-GANG LIANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/684,188

(22) Filed: Nov. 22, 2012

(30) Foreign Application Priority Data
Nov. 15, 2012 (CN) 2012104589995

(51) Int. Cl. H02G 3/02

(52) U.S. Cl. CPC H02G 3/02
USPC 174/652

(57) ABSTRACT

A cable management apparatus for binding cables includes a mounting plate and a cable clamp. The mounting plate defines an opening for receiving the cables. The cable clamp includes a resilient position member. The cable clamp is attached to the opening, the position member is abut to the cables received in the opening.

### BACKGROUND

1. Technical Field

The present disclosure relates to a cable management apparatus.

2. Description of Related Art

There are often a large number of cables in an electronic device, and a mounting plate supporting hard disk drives or fans is mounted in the electronic device. Ordinarily, the mounting plate defines a through hole for cables to extend through. However, if the through hole has small size, the cables cannot be extended through the through hole; and if the through hole has large size, the cables are easily get tangled together. Tangled condition of the cables may inhibit heat dissipation of the electronic device.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric cutaway view of an exemplary embodiment of a cable management apparatus.

FIG. 2 is an enlarged view of the circled portion II of FIG. 1.

FIG. 3 is an assembled, isometric view of FIG. 2, showing the cable management apparatus in use.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

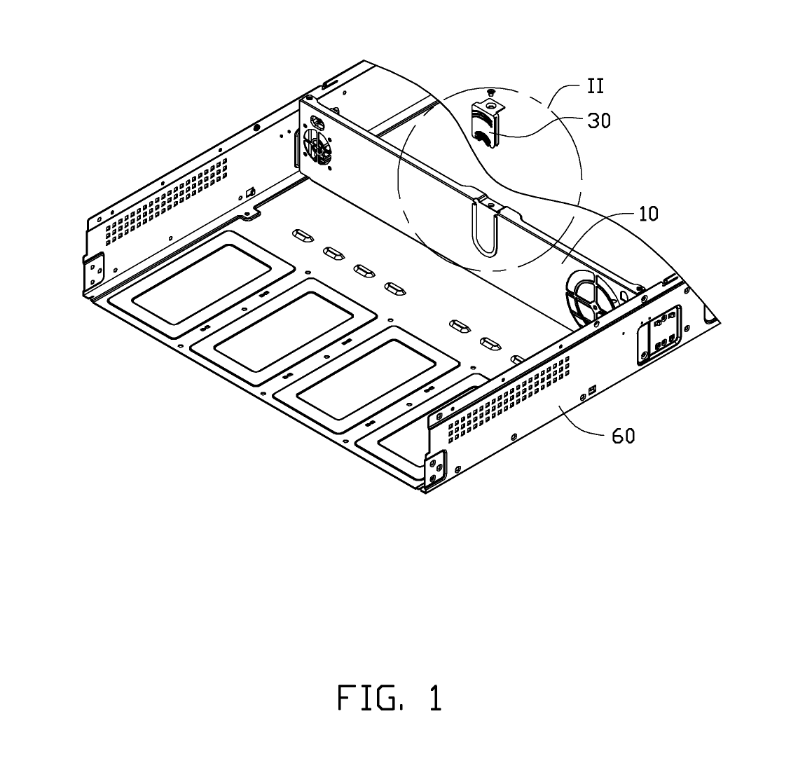

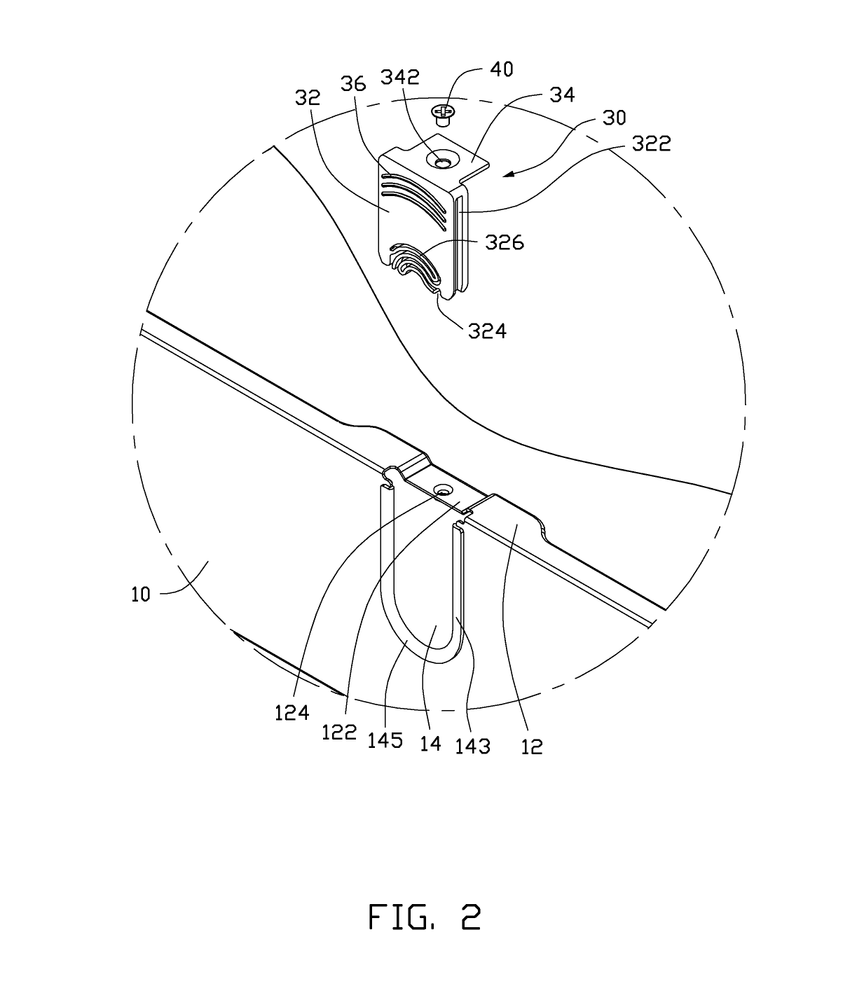

FIG. 1 and FIG. 2 show an exemplary embodiment of a cable management apparatus. The cable management apparatus includes a mounting plate 10 mounted in an enclosure 60 and a cable clamp 30. In the embodiment, the mounting plate 10 is used to fix fans.

A position plate 12 perpendicularly extends out from a top of the mounting plate 10. The mounting plate 10 defines a substantially U-shaped opening 14 adjacent to the position plate 12, and an open end of the opening 14 extends through the position plate 12. The opening 14 is bound by two opposite side edges 143 and an arc-shaped bottom edge 145 connected between two bottom ends of the side edges 143. The position plate 12 defines a recess 122 aligning with the opening 14. The recess 122 defines a screw hole 124 in a middle of the recess 122.

The cable clamp 30 includes a substantially rectangular slide plate 32 and a tab 34 perpendicularly extending from a top of the slide plate 32 toward one side of the slide plate 32. A plurality of bar-shaped anti-skid portions 36 protrude from an upper portion of the other side of the slide plate 32 for expediently operating the cable clamp 30. The tab 34 defines a through hole 342 in a middle of the tab 34.

The slide plate 32 defines two opposite slide slots 322 in two side surfaces of the slide plate 32. Each slide slot 322 extends along the longwise direction of the slide plate 32 perpendicular to the tab 34 and extends through a bottom surface of the slide plate 32. The bottom of the slide plate 32 defines a U-shaped cutout 324. Two snake-shaped and resilient position members 326 respectively extend in from two opposite sidewalls bounding the cutout 324. The position bars 326 are arced up.

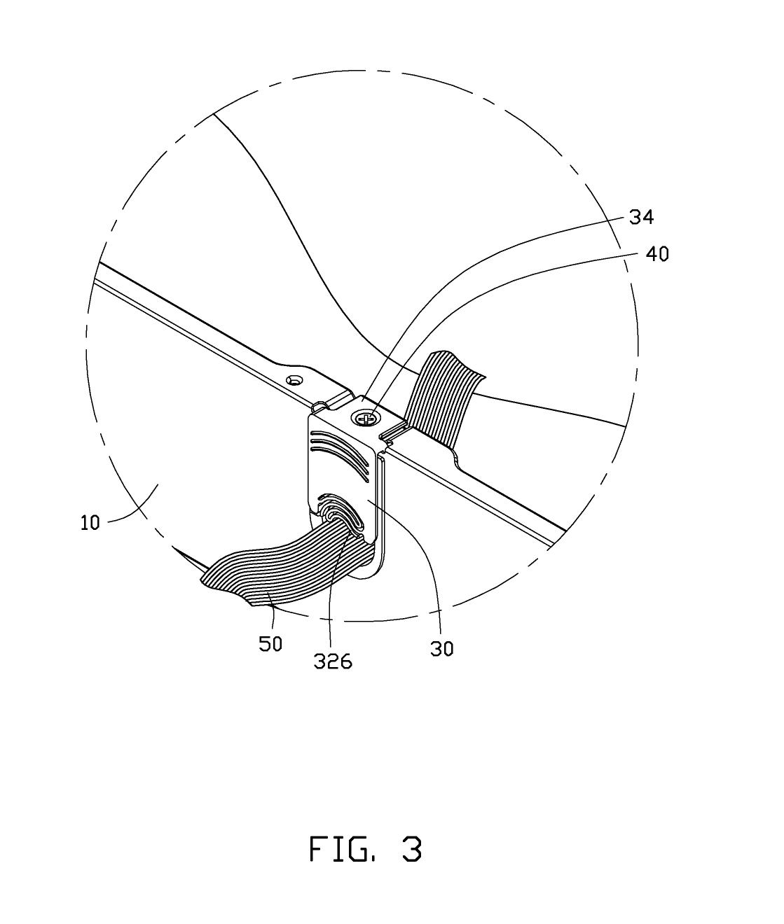

FIG. 3 shows the mounting apparatus 100 in use, a plurality of cables 50 is inserted in the opening 14. The cable clamp 30 is inserted into the opening 14. The side edges 143 bounding the opening 14 are slidably received in the slide slots 322 of the slide plate 32, respectively. The position members 326 are deformed up by the cables and resiliently abut the cables 50. The tab 34 is received in the recess 122 of the position plate 12. A screw 40 is extended through the through hole 342, to be screwed into the screw hole 124. Thereby, the cables 50 are collected and sandwiched between the bottom edge 145 bounding the opening and the cable clamp 30.

It is to be understood, however, that even though numerous characteristics and advantages of the embodiments have been set forth in the foregoing description, together with details of the structure and function of the embodiments, the present disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A cable management apparatus for binding cables, the cable management apparatus comprising:
a mounting plate defining an opening for receiving the cables; and
a cable clamp comprising a resilient position member;
wherein the cable clamp is attached to the opening, and the position member is abut to the cables received in the opening.

2. The cable management apparatus of claim 1, wherein the opening is substantially U-shaped, and is bound by two opposite side edges, an open end of the opening extends through a top of the mounting plate, the cable clamp comprises a rectangular slide plate defining two slide slots in two opposite side surfaces of the slide plate, each slide slot extends along the longwise direction of the slide plate and extends through a bottom surface of the slide plate, the side edges are respectively received in the slide slots.

3. The cable management apparatus of claim 2, wherein the mounting plate further comprises a position plate extending out from a top of the mounting plate, the open end of the opening extends through the position plate, the cable clamp further comprises a tab extending from a top of the slide plate, the position plate defines a screw hole, the tab defines a through hole, a screw extends through the through hole of the tab, to be screwed to the screw hole of the position plate.

4. The cable management apparatus of claim 3, wherein the position plate defines a recess aligning with the opening for receiving the tab, the screw hole is defined in the recess.

5. The cable management apparatus of claim 3, wherein a plurality of anti-skid portions protrudes from an upper portion of the slide plate opposite to the tab.

6. The cable management apparatus of claim 2, wherein a bottom of the slide plate defines a substantially U-shaped cutout, the position member is formed in the cutout.

7. The cable management apparatus of claim 6, wherein the position member is curved, and extends from a sidewall bounding the cutout.
